(19) United States
(12) Patent Application Publication
(10) Pub. No.: US 2010/0027869 A1
(43) Pub. Date: Feb. 4, 2010

(54) Optical Carriage Structure of Inspection Apparatus and its Inspection Method

(75) Inventors: Chin-Lai Wu, Hsinchu (TW); Chih-Kuang Yang, Hsinchu-City (TW)

Correspondence Address: Cooper Legal Group LLC, 6505 Rockside Road, Suite 330, Independence, OH, 44131, US

(73) Assignee: Shanghai Microtek Technology Co., Ltd., Shanghai (CN)

(21) Appl. No.: 12/203,531

(22) Filed: Sep. 3, 2008

(30) Foreign Application Priority Data
Aug. 4, 2008 (TW) 97129577

(51) Int. Cl. G06K 9/00; H04N 1/04

(52) U.S. Cl. 382/141; 358/494

(57) ABSTRACT

An optical carriage structure of the inspection apparatus and its inspection method are disclosed herein. A plurality of CCD arrays configured at different heights in the optical carriage are utilized, so as a plurality of individual images can be simultaneously captured in one scanning step to obtain a preferred inspection image for image comparison; therefore, precise inspection can be effectively achieved. Furthermore, those CCD arrays are configured at different heights and have enlarged focusing ranges, and the depth of field is thus enhanced.

### BACKGROUND OF THE INVENTION

1. Field of the Invention

The present invention relates to an image inspection technique, and more particularly to an optical carriage structure of an inspection apparatus and its inspection method.

2. Description of the Prior Art

The drawback of industrial inspection by manual operation includes lower inspection speed and possible misjudgment. In addition, the difficulty of manual inspection increases with the increased complexity of sample. On the other hand, conventional industrial inspection apparatuses utilize scanners or cameras to obtain sample images for subsequent comparison; however, these industrial inspection apparatuses cost very much.

An optical carriage is configured within a scanner and connected to and driven by a stepping motor to move smoothly on a slide rail. The optical carriage usually includes an optical sensor array focusing and imaging a reflective or a transmitting light to a lens of the optical sensor array. A charge coupled device (CCD) is a commonly used linear optical sensor array and of reasonable price and good quality. The CCD array is stripe-shaped and comprises connected CCD. Each CCD represents a pixel, in which DPI (dots per inch) represents the resolution of the pixel. For example, the resolution 1200 dpi represents 1200 pixels per inch. A single-row grayscale CCD array is adopted in black and white scanning, and a three-row RGB CCD array is adopted in color scanning. As illustrated in FIG. 1, a RGB array 100 includes a red array 110, a green array 120, and a blue array CCD 130 respectively detecting the red, green, and blue imaging light, which is merged into a color image data, subsequently saved and output.

Assuming the same length of CCD arrays, for faster scanning speed, higher resolution as well as better and clear image quality, to increase pixels would decrease the dimension of single optical sensor and result in decreased photosensitivity and signal to noise ratio (S/N ratio). Hence, exposure time of scanning must be increased for enhancing the S/N ratio to obtain scanning images of the same quality; therefore, the scanning speed is decreased due to the increased scanning time. The above description illustrates the drawback of enhancing the resolution by increasing pixels.

However, in case of height difference of the sample surface, only components within a particular height can be captured clearly due to a single focal point of CCD. If the height difference of sample surface exceeds the tolerable focusing range of CCD greatly, the image comparison result would be severely influenced, e.g. a printed circuit board (PCB) with components of great height difference and high density in industrial inspection.

To sum up, it is now a current goal to achieve faster and more precise inspection.

### SUMMARY OF THE INVENTION

The present invention is directed to provide an optical carriage structure of an inspection apparatus and its inspection method including a plurality of charge coupled device (CCD) arrays configured at different heights in the optical carriage, so as a plurality of individual images can be simultaneously captured in one scanning step to obtain a preferred inspection image for image comparison.

The present invention is directed to provide an optical carriage structure of an inspection apparatus and its inspection method including a plurality of CCD arrays configured at different heights in the optical carriage, so as those CCD arrays have enlarged focusing ranges and the depth of field is thus enhanced.

In an aspect, an optical carriage structure of an inspection apparatus includes a base, a first linear optical sensor array, and a second linear optical sensor array. The first linear optical sensor array and the second linear optical sensor array are configured at different heights in the base. A focal length of the first linear optical sensor array is equal to a vertical distance of the first linear optical sensor array to a first feature of a sample, and a focal length of the second linear optical sensor array is equal to a vertical distance of the second linear optical sensor array to a second feature of the sample.

In another aspect, an inspect method includes defining a scanning area and arranging a sample onto the scanning area; capturing a first image of the scanning area by using the first linear optical sensor array; capturing a second image of the scanning area by using the second linear optical sensor array, wherein the first image and the second image are simultaneously captured in one scanning step; and comparing the first image and the second image to a data image of the sample.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a diagram illustrating a RGB CCD array according to a prior art;

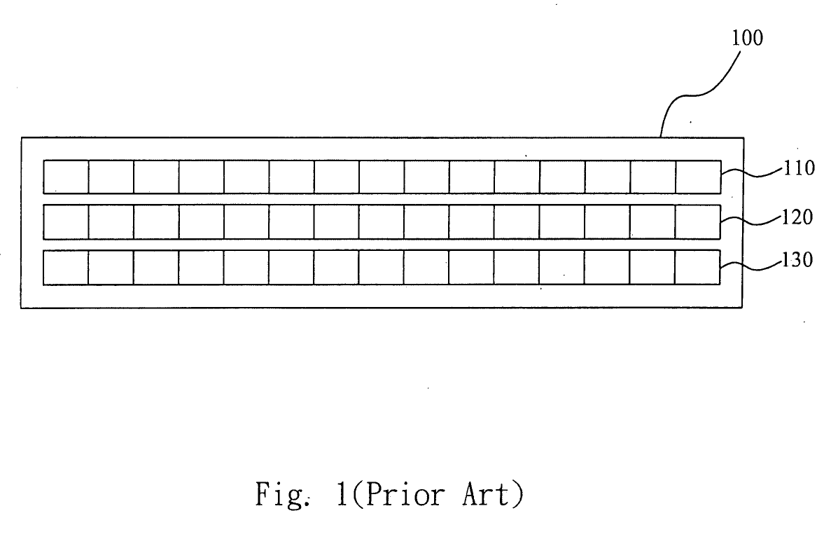

FIG. 2 is a diagram illustrating an embodiment of the present invention;

FIG. 3 is a diagram illustrating an embodiment of the present invention; and

FIG. 4 is a flow chart illustrating an embodiment of the present invention.

### DESCRIPTION OF THE PREFERRED EMBODIMENT

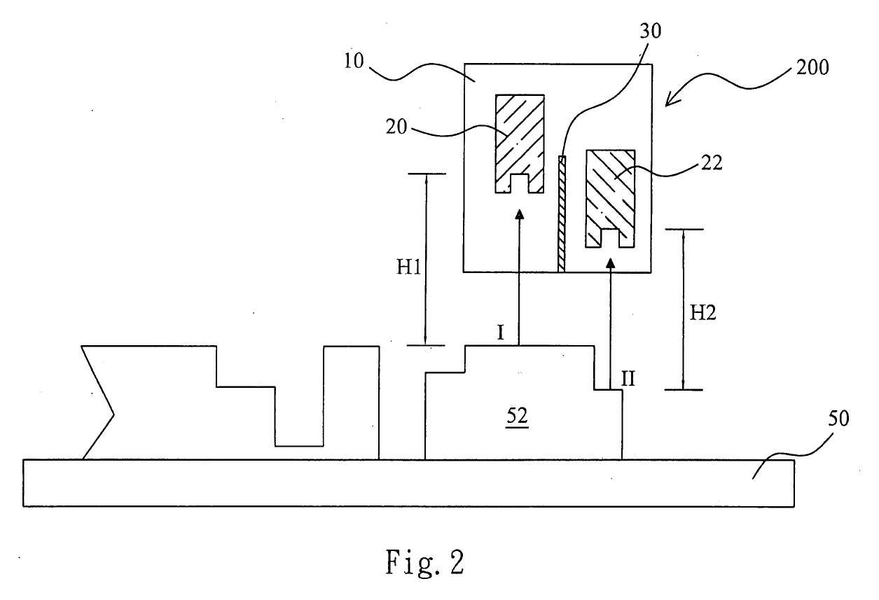

FIG. 2 is a cross-sectional diagram illustrating an optical carriage structure of an inspection apparatus according to an embodiment of the present invention. The optical carriage 200 structure includes a base 10, a first linear optical sensor array 20, and a second linear optical sensor array 22. The first linear optical sensor array 20 and the second linear optical sensor array 22 are configured at different heights in the base 10. A focal length of the first linear optical sensor array 20 is equal to a vertical distance H1 of the first linear optical sensor array 20 to a first feature I of a sample 52, and a focal length of the second linear optical sensor array 22 is equal to a vertical distance H2 of the second linear optical sensor array 22 to a second feature II of the sample 52.

In an embodiment, a spacer 30 is configured in the base 10 to separate an optical path of the first linear optical sensor array 20 from an optical path of the second linear optical sensor array 22. In another embodiment, a plurality of notches (not shown) are configured in the base 10 to house the first linear optical sensor array 20 and the second linear optical sensor array 22 and to separate the optical paths thereof. The optical carriage 260 may further include a light source configured within the base 10. The light source, for example, may be a cold cathode fluorescent lamp (CCFL) or other visible light sources.

Next, the first linear optical sensor array 20 and the second linear optical sensor array 22 may comprise a charge coupled device (CCD) array, e.g. a RGB CCD array or a monochrome CCD array. In an embodiment, the number of adopted linear optical sensor array is not limited to two; three or more linear optical sensor arrays may be adopted.

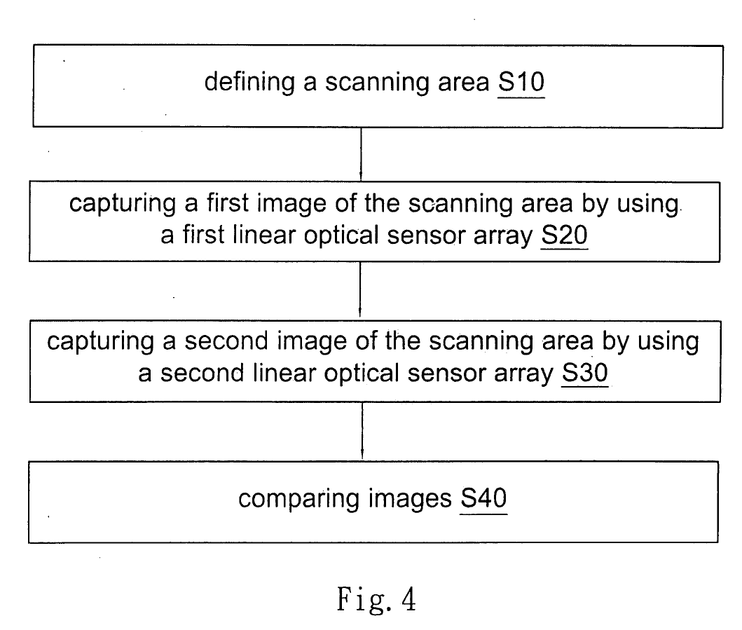

Referring to FIG. 4, an inspection method adopting the above-mentioned optical carriage structure of the inspection apparatus is described as follows. First of all, a scanning area is defined and a sample is arranged onto the scanning area (step S10). Next, a first image of the scanning area is captured by using a first linear optical sensor array (step S20), and a second image of the scanning area is captured by using the second linear optical sensor array (step S30), wherein the first image and the second image are simultaneously captured in one scanning step. Finally, the first image and the second image are compared to a data image of the sample (step S40).

According to the above-mentioned description, a preferred inspection image may be chosen from the first image, the second image, or an image merged from the first image and the second image. In an embodiment, in case of three or more linear optical sensor arrays, the preferred inspection image may be chosen or merged from the individual images. In another embodiment, the first image and the second image are respectively compared to the data image of the sample.

Also referring to FIG. 2, in an embodiment, the present invention further includes a focusing step to adjust the focal length of the first linear optical sensor array 20 equal to the vertical distance H1 of the first linear optical sensor array 20 to the first feature I of the sample 52 and the focal length of the second linear optical sensor array 22 equal to the vertical distance H2 of the second linear optical sensor array 22 to the second feature II of the sample 52. The above-mentioned focusing step may be achieved by using an auto-focusing software or adjusting the vertical distance of the first linear optical sensor array 20 and the second linear optical sensor array 22 from the sample 52. In addition, the focal lengths of the first linear optical sensor array 20 and the second linear optical sensor array 22 may be the same or different.

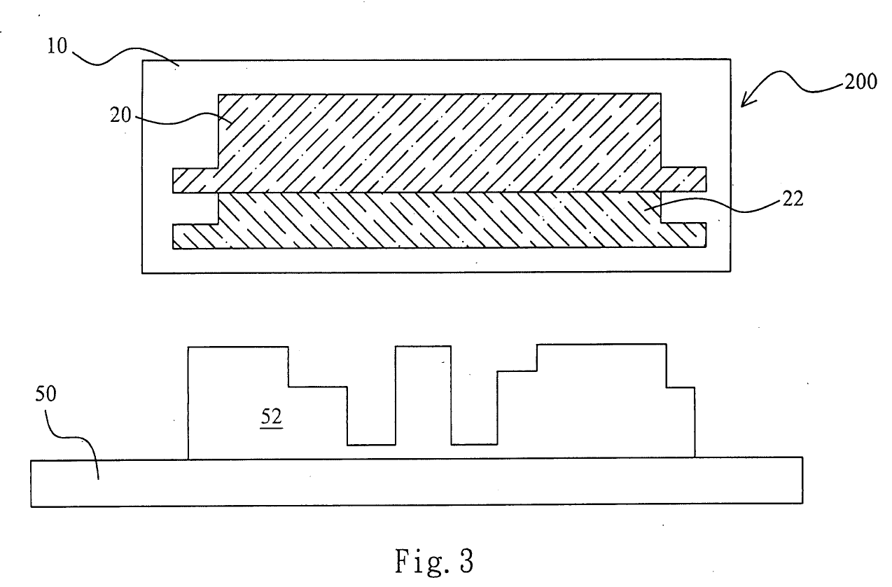

In an embodiment, components on a printed circuit board are used as targets for inspection, for example. Refer to FIG. 2 and FIG. 3, which are diagrams illustrating different cross-section of the optical carriage. The printed circuit board 50 comprises a plurality of components with different heights, e.g. a sample 52, in the embodiment. First of all, a scanning area is defined and the printed circuit board 50 is arranged onto the scanning area.

The optical carriage 200 may be moved and the printed circuit board 50 may be placed on a carrying apparatus for motion in the XY-plane by programmed control; on the other hand, the optical carriage may be mounted and the printed circuit board 50 may be placed on a conveyor (not shown) for movement. The first linear optical sensor array 20 and the second optical sensor array 22 are configured at different heights in the base 10 and may pass through the sample 52 using their scanning lines in a sequential way. The first linear optical sensor array 20 and the second optical sensor 22 receive the reflective light from the surface of the sample 52 and capture a first image and a second image, which are subsequently converted electronic, data and saved in the memory of the inspection apparatus after completion of scanning.

The surfaces of components of the sample 52 in the XY-plane have obvious difference of heights as illustrated in FIG. 2, and the CCD arrays having focusing function look for the preferred focal point prior to running scanning lines and subsequently capture the whole image by filling the sample 52. Various CCD arrays may obtain a partial preferred image in case that the height difference of the sample surface is greater than the depth of field of the CCD arrays. Therefore, the optical carriage comprising two or more CCD arrays at different heights of the present invention may effectively enhance the depth of field.

Referring to FIG. 3, a CCD can only focus on one particular height at one time; hence, in case of height difference of the sample 52, the CCD can only focus at one particular height while scanning in the XY-plane, other heights can not be the focal point, and those out of the depth of field of the CCD array would become blurred on the captured image. According to the above description, the CCD arrays configured at different heights have different focusing ranges while scanning the same cross-section. Therefore, in this embodiment, the CCD arrays configured at different heights scan the same cross-section of the sample 52 to capture a plurality of individual images, e.g. a first image and a second image, which are subsequently compared to the data images for accuracy, and the inspection precision is thus enhanced.

To sum up, the present invention utilizes a plurality of CCD arrays configured at different heights in an optical carriage, so as a plurality of individual images can be simultaneously captured in one scanning step to obtain a preferred inspection image for image comparison; therefore, precise inspection can be effectively achieved. Furthermore, those CCD arrays configured at different heights have enlarged focusing ranges, and the depth of field is thus enhanced.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. An optical carriage structure of an inspection apparatus, comprising:
a base;
a first linear optical sensor array; and
a second linear optical sensor array.;
wherein the first linear optical sensor array and the second linear optical sensor array are configured at different heights in the base;
a focal length of the first linear optical sensor array is equal to a vertical distance of the first linear optical sensor array to a first feature of a sample; and
a focal length of the second linear optical sensor array is equal to a vertical distance of the second linear optical sensor array to a second feature of the sample.

2. The optical carriage structure as claimed in claim 1, wherein the first iinear optical sensor array and the second linear optical sensor array comprise a charge coupled device (CCD) array.

3. The optical carriage structure as claimed in claim 2, wherein the CCD array comprises a RGB CCD array or a monochrome CCD array.

4. The optical carriage structure as claimed in claim 1, further comprising a spacer configured in the base and used for separating an optical path of the first linear optical sensor array from an optical path of the second linear optical sensor array.

5. The optical carriage structure as claimed in claim 1, further comprising a plurality of notches configured at in the base, wherein the notches house the first linear optical sensor array and the second linear optical sensor array and separate an optical path of the first linear optical sensor array from an optical path of the second linear optical sensor array.

6. The optical carriage structure as claimed in claim 1, further comprising a light source configured within the base.

7. The optical carriage structure as claimed in claim 1, further comprising a third linear optical sensor array, wherein a focal length of the third linear optical sensor array is equal to a vertical distance of the third linear optical sensor array to a third feature of the sample.

8. An inspection method using the optical carriage structure of the inspection apparatus as claimed in claim 1, comprising:
defining a scanning area and arranging a sample onto the scanning area;
capturing a first image of the scanning area by using the first linear optical sensor array;
capturing a second image of the scanning area by using the second linear optical sensor array, wherein the first image and the second image are simultaneously captured in one scanning step; and
comparing the first image and the second image to a data image of the sample.

9. The inspection method as claimed in claim 8, further comprising a focusing step to adjust the focal length of the first linear optical sensor array equal to the vertical distance of the first linear optical sensor to the first feature of the sample and the focal length of the second linear optical sensor array equal to the vertical distance of the second linear optical sensor array to the feature of the sample.

10. The inspection method as claimed in claim 9, wherein the focusing step is achieved by using an auto-focusing software.

11. The inspection method as claimed in claim 9, the focusing step is achieved by adjusting the distance of the vertical distance of the first linear optical sensor array and the second linear optical sensor array from the sample.

12. The inspection method as claimed in claim 8, further comprising: choosing a preferred inspection image from the first image and the second image to compare with the data image of the sample.

13. The inspection method as claimed in claim 8, further comprising: merging a preferred inspection image from the first image and the second image to compare with the data image of the sample.

14. The inspection method as claimed in claim 8, wherein the first image and the second image are respectively compared to the data image of the sample.

15. The inspection method as claimed in claim 8 further comprising capturing a third image of the scanning area by using a third linear optical sensor array to obtain a preferred inspection image based on the first image, the second image, and the third image.
